(19) United States
(12) Patent Application Publication
(10) Pub. No.: US 2026/0353488 A1
(43) Pub. Date: Nov. 5, 2026

(54) AUDIO PROCESSING APPARATUS, INFORMATION PROCESSING APPARATUS, AUDIO PROCESSING SYSTEM, CONTROL METHOD, AND STORAGE MEDIUM THAT ENABLE PHOTOGRAPHER TO EASILY AND INDIVIDUALLY COMMUNICATE WITH A PLURALITY OF PERSONS AS SUBJECTS AT A DISTANCE BY USING SIMPLE SYSTEM CONFIGURATION

(71) Applicant: CANON KABUSHIKI KAISHA, Tokyo (JP)

(72) Inventor: RYOHEI HAMAGUCHI, Mie (JP)

(21) Appl. No.: 19/550,854

(22) Filed: Feb. 26, 2026

(30) Foreign Application Priority Data
Mar. 3, 2025 (JP) 2025-032701

(51) Int. Cl. H04W 76/15; H04B 1/16; H04B 11/00; H04W 76/14

(52) U.S. Cl. CPC H04W 76/15; H04B 1/1615; H04B 11/00; H04W 76/14

(57) ABSTRACT

A mechanism enabling a photographer to individually communicate with multiple persons at a distance using a simple system configuration is provided. An image pickup apparatus obtains the voice of a photographer (a first audio signal) using a sound pickup unit, and when receiving via wireless communication the voices of users B and C (second and third audio signals) from sound pickup devices used by the users B and C, generates audio signals of multiple channels from the first to third audio signals and delivers them via wireless communication to a receiver, while also delivering an advertisement for each channel to an assistant. When the photographer changes a mute setting of a channel selected by the receiver on a mute setting screen, the image pickup apparatus changes the state of the receiver by changing information about the mute setting included in the advertisement of the channel to be delivered.

### BACKGROUND

### Field of the Technology

The present disclosure relates to an audio processing apparatus, an information processing apparatus, an audio processing system, a control method, and a storage medium, and more particularly to an audio processing apparatus, an information processing apparatus, an audio processing system, a control method, and a storage medium, to which Auracast™ broadcast audio is applied.

### Description of the Related Art

In recent years, electronic apparatuses equipped with wireless transmitting and receiving units conforming to the Bluetooth Low Energy (hereinafter, abbreviated as BLE) standard, which is capable of achieving lower power consumption than conventional Bluetooth (registered trademark), have become widespread.

Furthermore, the Bluetooth Special Interest Group has announced (released) the Auracast™ Broadcast Audio (hereinafter, simply referred to as Auracast™), and after the release of the Auracast™, it is being considered to incorporate the Auracast™ into electronic apparatuses.

The Auracast™ is a system that includes an Auracast™ Transmitter (hereinafter, simply referred to as “a transmitter”) and an Auracast™ Receiver (hereinafter, simply referred to as “a receiver”). This system is a system that allows any number of receivers located within a predetermined range from the transmitter to participate in broadcast transmission from the transmitter. A non-patent literature (Nick Hunn, “Introducing Bluetooth LE Audio”, pp. 277-294) provides an overview of the Auracast™ (in the non-patent literature, the Auracast™ is referred to as Broadcast).

In addition to the transmitter and the receiver, the Auracast™ is system-configured to include an Auracast™ Assistant (hereinafter, simply referred to as “an assistant”).

The transmitter is a transmitting device for transmitting audio data or an audio file to unspecified receivers. The audio data or the audio file transmitted by the transmitter is provided from a device that serves as a sound source connected to the transmitter or a device that stores the audio data or the audio file.

The assistant is provided in an information processing apparatus that is capable of scanning advertisements from a plurality of transmitters, and advertisements on a plurality of channels from one transmitter. The assistant accepts a user selection with respect to one of the plurality of transmitters or one of the plurality of channels, in response to the scanned advertisements. The transmitter provides the assistant with information necessary for receiving audio data to be delivered from a transmitter user-selected by the assistant or audio data of a channel user-selected by the assistant.

Here, examples of the information processing apparatus provided with the assistant include a smartphone and a personal computer.

The assistant provides a pre-paired receiver, which is provided in the same apparatus as the assistant or an apparatus different from the assistant, with information necessary for connecting to the audio data or the audio file provided by the user-selected transmitter.

Here, the receiver is a device that captures, and outputs or records the audio data or the audio file transmitted from the user-selected transmitter. The receiver may be an audio output device such as a headphone, an earphone or a speaker, or may be a recording device for recording audio data or audio files.

The Auracast™ is expected to be used, for example, to watch a television installed in a public area with sound, and to directly receive an announcement at an airport, a train station, or the like.

There is also an opportunity for the Auracast™ to be used in a camera. For example, in the case where a camera is used as a transmitter, a plurality of persons are capable of simultaneously listening to audio reproduced by one camera by using receivers such as headphones, respectively. For example, the Auracast™ is capable of being used in a scene of efficiently photographing persons who use receivers located away from a camera by sharing, with the receivers, audio obtained by a microphone built into the camera.

An example of a photographing method used by a photographer in such a scene will be described. In a scene where a still image of a person is to be photographed, there is a case where the person to be photographed (the person being a subject) is positioned at a distance away from the camera. Examples of such a case include the case of performing photographing using a telephoto lens and the case of performing photographing of larger view of the landscape using a wide-angle lens.

A photographer is about to use an image pickup apparatus to photograph a first subject person and a second subject person. At this time, it is assumed that a distance between the photographer and the first subject person and a distance between the photographer and the second subject person are large, and the photographer is at a distance where oral communication with the first subject person and the second subject person is not possible.

In a situation, the photographer may wish to instruct the first subject person and the second subject person on their positions, facial expressions, and poses. However, if the photographer is at a distance where oral communication with the first subject person and the second subject person is not possible, there will be an issue in that it is difficult for the photographer to issue instructions to the first subject person and the second subject person. One solution to this issue is to use a wireless headphone to allow communication with the subject person. By pairing the image pickup apparatus owned by the photographer with the wireless headphone owned by the subject person, instructions from the photographer are capable of being transmitted wirelessly to the first subject person and the second subject person.

However, in photographing using the wireless headphone that has been described above, in particular, in the case where there are a plurality of persons being subjects such as the first subject person and the second subject person, a further issue arises. In the case where there are a plurality of persons being subjects, wireless headphones corresponding to the number of the plurality of persons are required, but the image pickup apparatus has an issue in that the system configuration becomes more complicated as the number of the wireless headphones that are paired and connected to the image pickup apparatus increases. Furthermore, implementing such a complicated system configuration increases the necessary costs.

On the other hand, by using the Auracast™ that has been disclosed in the above-described non-patent literature, it becomes possible to transmit audio data from the image pickup apparatus to the wireless headphones used by the plurality of persons being subjects by using a simple system configuration. However, if the image pickup apparatus transmits audio data of the photographer's instructions to all connected wireless headphones at the same time, there will be an issue in that the photographer is not able to individually issue photographing instructions to the plurality of persons being subjects.

### SUMMARY

The present disclosure provides an audio processing apparatus, an information processing apparatus, an audio processing system, a control method, and a storage medium that enable a photographer to individually communicate with a plurality of persons as subjects at a distance by using a simple system configuration.

Accordingly, a first aspect of the present disclosure provides an audio processing apparatus used by a first user, the audio processing apparatus comprising an audio obtaining unit configured to obtain a voice of the first user as a first audio signal, a first wireless receiving unit configured to receive, via wireless communication, from a first sound pickup device used by a second user located within a predetermined range centered on the audio processing apparatus, a voice of the second user, which is obtained as a second audio signal by the first sound pickup device, a second wireless receiving unit configured to receive, via wireless communication, from a second sound pickup device used by a third user located within the predetermined range, a voice of the third user, which is obtained as a third audio signal by the second sound pickup device, an audio signal processing unit configured to process the first audio signal, the second audio signal, and the third audio signal, and generate audio signals of a plurality of channels, a first wireless delivering unit configured to deliver, via wireless communication, the audio signals of the plurality of channels, which have been generated by the audio signal processing unit, to a receiver located within the predetermined range, a second wireless delivering unit configured to deliver additional information associated with each of the plurality of channels to an assistant that is located within the predetermined range and that transmits and receives signals to and from the receiver via wireless communication, and a switching component configured to switch a mute setting of each of the plurality of channels between an ON state and an OFF state in response to a user operation by the first user. The additional information includes information about the mute setting of the associated channel. In a case where the mute setting of a channel being selected by the receiver among the plurality of channels has been switched by the switching component, the information about the mute setting included in the additional information of the channel being selected by the receiver, which is delivered by the second wireless delivering unit, is changed to change a state of the receiver.

Accordingly, a second aspect of the present disclosure provides an information processing apparatus used by a second user located within a predetermined range centered on an audio processing apparatus, the information processing apparatus comprising a first wireless communication unit configured to transmit and receive signals to and from a reproducing device, which is used by the second user and is located within the predetermined range, via wireless communication, and a second wireless communication unit configured to receive, via wireless communication, additional information delivered by the audio processing apparatus. The reproducing device is controlled by using the additional information received by the second wireless communication unit.

Accordingly, a third aspect of the present disclosure provides an audio processing system that comprises an audio processing apparatus used by a first user and an assistant located within a predetermined range centered on the audio processing apparatus. The audio processing apparatus comprises an audio obtaining unit configured to obtain a voice of the first user as a first audio signal, a first wireless receiving unit configured to receive, via wireless communication, from a first sound pickup device used by a second user located within the predetermined range, a voice of the second user, which is obtained as a second audio signal by the first sound pickup device, a second wireless receiving unit configured to receive, via wireless communication, from a second sound pickup device used by a third user located within the predetermined range, a voice of the third user, which is obtained as a third audio signal by the second sound pickup device, an audio signal processing unit configured to process the first audio signal, the second audio signal, and the third audio signal, and generate audio signals of a plurality of channels, a first wireless delivering unit configured to deliver, via wireless communication, the audio signals of the plurality of channels, which have been generated by the audio signal processing unit, to a receiver located within the predetermined range, a second wireless delivering unit configured to deliver additional information associated with each of the plurality of channels to the assistant, and a switching component configured to switch a mute setting of each of the plurality of channels between an ON state and an OFF state in response to a user operation by the first user. The additional information includes information about the mute setting of the associated channel. In a case where the mute setting of a channel being selected by the receiver among the plurality of channels has been switched by the switching component, the information about the mute setting included in the additional information of the channel being selected, which is delivered by the second wireless delivering unit, is changed to change a state of the receiver. An information processing apparatus, which is used by the second user and serves as the assistant, comprises a first wireless communication unit configured to transmit and receive signals to and from a reproducing device, which is used by the second user and serves as the receiver, via wireless communication, and a second wireless communication unit configured to receive, via wireless communication, the additional information of the channel being selected. The reproducing device is controlled by using the additional information of the channel being selected, which has been received by the second wireless communication unit.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of an image pickup apparatus as an audio processing apparatus according to an embodiment of the present disclosure.

FIG. 2 is a block diagram that illustrates a wireless connection configuration of an audio processing system according to the embodiment of the present disclosure.

FIG. 3A is a block diagram that illustrates a detailed configuration of a wireless connection configuration and an audio communication configuration of the image pickup apparatus.

FIG. 3B is a block diagram that illustrates the details of a hardware configuration of a sound pickup device shown in FIG. 2.

FIG. 3C is a block diagram that illustrates a hardware configuration of a reproducing device shown in FIG. 2 and a hardware configuration of a reproduction information selecting apparatus as an information processing apparatus according to the embodiment of the present disclosure.

FIG. 4A, FIG. 4B, FIG. 4C, FIG. 4D, and FIG. 4E are diagrams that illustrate the contents of audio data and advertisements delivered by the image pickup apparatus, which serves as a transmitter.

FIG. 5 is a flowchart of an audio mute control processing executed by the image pickup apparatus, which is the transmitter.

FIG. 6 is a flowchart of an audio mute control processing executed by the reproduction information selecting apparatus, which is an assistant.

FIG. 7 is a flowchart of an audio mute control processing executed by the reproducing device, which is a receiver.

FIG. 8 is a diagram for explaining audio mute control of the receiver and the assistant according to the state of the audio data and the advertisement for each channel delivered by the image pickup apparatus.

FIG. 9 is a diagram for illustrating an example of a scene in which a photographer photographs a plurality of subjects at a distance.

FIG. 10 is a diagram that illustrates a mute setting screen displayed on a display unit shown in FIG. 1.

### DESCRIPTION OF THE EMBODIMENTS

The present disclosure will now be described in detail below with reference to the accompanying drawings showing embodiments thereof.

Hereinafter, an embodiment of the present disclosure will be described in detail with reference to the accompanying drawings.

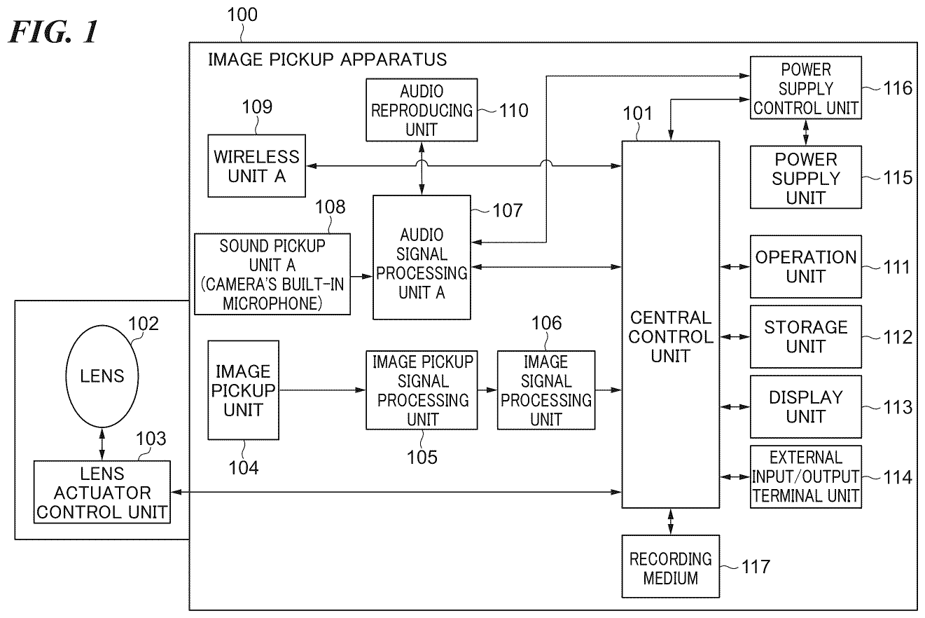

FIG. 1 is a block diagram that illustrates a hardware configuration of an image pickup apparatus 100 as an audio processing apparatus according to the embodiment of the present disclosure.

As shown in FIG. 1, the image pickup apparatus 100 is an apparatus that includes a function as a transmitter (to be described below) in an audio processing system according to the embodiment of the present disclosure and an image pickup function including an optical lens unit, and is equipped with a detachable lens 102.

The detachable lens 102 is a lens unit, and includes a photographing optical system (hereinafter, referred to as “a lens 102”), which includes a zooming unit, an aperture and shutter unit, a focusing unit, etc., and a lens actuator control unit 103 that controls the lens 102.

The image pickup apparatus 100 includes a central control unit 101, an image pickup unit 104, an image pickup signal processing unit 105, an image signal processing unit 106, an audio signal processing unit A 107, and a sound pickup unit A 108. Furthermore, the image pickup apparatus 100 includes a wireless unit A 109, an audio reproducing unit 110, an operation unit 111, a storage unit 112, a display unit 113, an external input/output terminal unit 114, a power supply unit 115, a power supply control unit 116, and a recording medium 117.

The image pickup unit 104 includes an image pickup device (an image sensor) such as a CMOS sensor or a CCD sensor, and performs photoelectric conversion on an optical image formed by the lens 102 to output electrical signals.

The lens actuator control unit 103 within the detachable lens 102 includes a motor driver IC, and drives various actuators for the zooming unit, the aperture and shutter unit, the focusing unit, etc., of the lens 102. The various actuators are driven based on actuator drive instruction data for the lens 102, which has been received from the central control unit 101 of the image pickup apparatus 100.

The sound pickup unit A 108 (an audio obtaining unit serving as an audio obtaining means) is an audio input unit that includes a microphone, and the sound pickup unit A 108 obtains the voice of a photographer who uses the image pickup apparatus 100 as an audio signal (a first audio signal), converts the audio signal into an electrical signal, and then converts the electrical signal further into a digital signal and outputs the digital signal.

The wireless unit A 109 (a first wireless receiving unit serving as a first wireless receiving means and a second wireless receiving unit serving as a second wireless receiving means) not only transmits signal(s) received from the central control unit 101 to external device(s) via wireless communication, but also transmits signal(s) received from the external device(s) via wireless communication to the central control unit 101.

The central control unit 101 is a central processing unit (a CPU) that controls the entire image pickup apparatus 100.

The image pickup signal processing unit 105 converts the electrical signals output from the image pickup unit 104 into video signals. The image signal processing unit 106 processes the video signals output from the image pickup signal processing unit 105 according to the intended use. Here, the processing of the video signals includes an electronic image stabilization operation by image cropping and rotation processing, and a subject detection means (not shown) for detecting subject(s). The audio signal processing unit A 107 (an audio signal processing unit serving as an audio signal processing means) performs audio processing with respect to audio signals from the sound pickup unit A 108 and the wireless unit A 109.

The operation unit 111 is provided to allow the user to operate the image pickup apparatus 100, and is configured to include operation members such as a main switch (not shown) that turns a main power supply of the image pickup apparatus 100 on and off, and a volume that corrects a sound pressure of audio data.

The storage unit 112 stores various kinds of information including parameters for processing photographing data and programs related to the control of the image pickup apparatus 100.

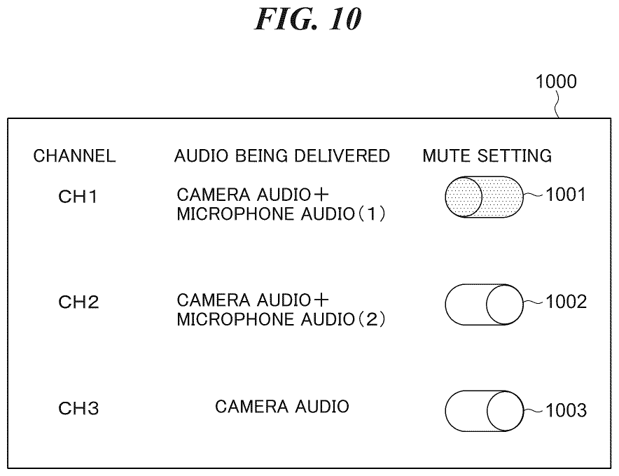

The display unit 113 is, for example, a touch panel display such as a liquid crystal display (an LCD) that is configured integrally with the operation unit 111, and performs image display as necessary based on signals output from the image signal processing unit 106, and also accepts user operations. For example, the display unit 113 image-displays a mute setting screen (a switching component serving as a switching means) shown in FIG. 10, which will be described below, and on the mute setting screen, a mute state (indicating whether to set to “muted” or “delivering”) of each channel, which will be described below, is capable of being changed by a user operation accepted by the operation unit 111.

The external input/output terminal unit 114 inputs and outputs communication signals and video signals to and from external device(s).

The audio reproducing unit 110 includes a speaker, converts audio data into an electrical signal, and causes to reproduce the audio.

The power supply unit 115 supplies power to the entire image pickup apparatus 100 (the respective components of the image pickup apparatus 100) depending on the intended use.

The power supply control unit 116 performs the control of individually turning on and turning off different types of power supplies of the power supply unit 115.

The recording medium 117 stores various kinds of data such as video information obtained by photographing, audio data picked up at the same time, and attribute information of object(s) (the subject(s)) detected by the subject detection means in association with each other.

The microphone included in the sound pickup unit A 108 is a microphone built into the image pickup apparatus 100, but it may also be configured to be a wired cable microphone that is capable of being connected by using, for example, a phone plug or the like, and audio data picked up is output as an analog signal. In this case, a wired connection is made via a microphone jack (not shown) mounted on the image pickup apparatus 100, and the analog signal from the wired cable microphone is input to the audio signal processing unit A 107.

Hereinafter, in the present embodiment, a case where the sound pickup unit A 108 is a microphone built into the image pickup apparatus will be described as an example.

Here, an object of the present disclosure and the configurations and operations for achieving the object will be described.

The object of the present disclosure is to provide an audio processing apparatus, an information processing apparatus, an audio processing system, a control method, and a storage medium that enable a photographer to easily and individually communicate with a plurality of persons as subjects at a distance by using a simple system configuration.

In order to realize the above-described simple system configuration, in the present embodiment, audio data is transmitted by using an audio processing system 1 that utilizes the Auracast™.

Generally, since the Auracast™ is a standard for performing transmission with respect to an unspecified number of persons, as a method for transmitting a reproduction instruction to only some of reproducing devices, the Auracast™ performs control based on an advertisement (advertisement control). More specifically, an assistant, which has received an advertisement from a transmitter, controls the operation of a receiver in accordance with the content of the received advertisement.

In order to solve the above issue, the central control unit 101 changes the advertisement to be delivered to each channel in accordance with the result of a decision made by the photographer 900 by using the operation unit 111. In the case where the mute state set by the received advertisement is “muted”, the assistant performs control with respect to the receiver so that the receiver mutes the reception of the audio signal. It should be noted that the assistant may perform control with respect to the receiver so that the receiver mutes not only the reception of the audio signal but also the transmission of the audio signal, or the assistant may perform control with respect to the receiver so that the receiver mutes the transmission of the audio signal instead of the reception of the audio signal.

The following describes in detail the change to the transmission content of the advertisement, the operation of the assistant that has received the advertisement, and the operation of the receiver.

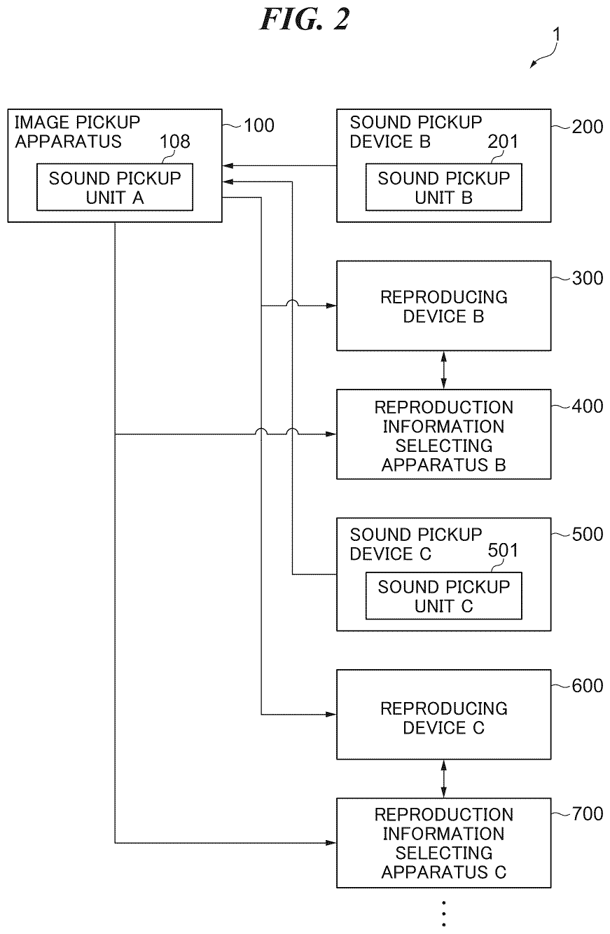

FIG. 2 is a block diagram that illustrates a wireless connection configuration of the audio processing system 1 according to the present embodiment. Hereinafter, the connection configuration of wireless devices that constitute the audio processing system 1 and the number of devices that are capable of being connected will be described with reference to FIG. 2.

As shown in FIG. 2, as described above, the audio processing system 1 is a system that utilizes the Auracast™, and the audio processing system 1 includes the image pickup apparatus 100, a sound pickup device B 200, a sound pickup device C 500, a reproducing device B 300, and a reproducing device C 600, a reproduction information selecting apparatus B 400, and a reproduction information selecting apparatus C 700. It should be noted that the audio processing system 1 may further include a plurality of sound pickup devices (not shown in FIG. 2), a plurality of reproducing devices (not shown in FIG. 2), and a plurality of reproduction information selecting apparatuses (not shown in FIG. 2) that have the same configuration as the sound pickup device B 200, the reproducing device B 300, and the reproduction information selecting apparatus B 400, respectively. In other words, if the number of devices/apparatuses for the sound pickup device, the reproducing device, and the reproduction information selecting apparatus is the same, the number of the sound pickup devices, the number of the reproducing devices, and the number of the reproduction information selecting apparatuses may be even greater than those of the configuration shown in FIG. 2.

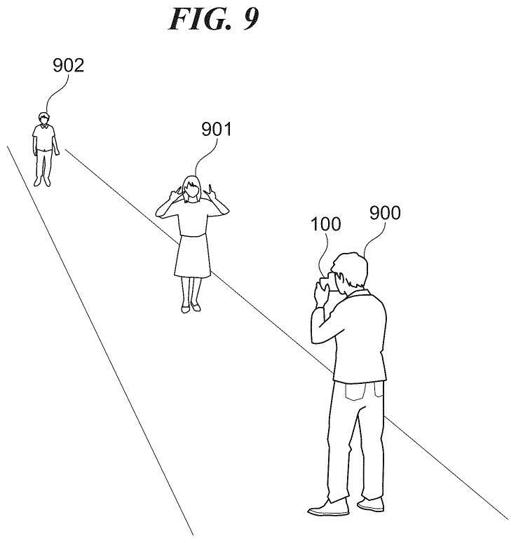

The image pickup apparatus 100 is an apparatus used by the photographer 900 (a first user) described below with reference to FIG. 9, which includes not only an image pickup function but also a function as a transmitter of the Auracast™.

The sound pickup device B 200 is a wireless microphone and includes a sound pickup unit B 201, and the sound pickup device C 500 is a wireless microphone and includes a sound pickup unit C 501. The sound pickup device B 200 (a first sound pickup device) is a device used by the first subject person 901 (a second user) described below with reference to FIG. 9, who is located within a predetermined range centered on the image pickup apparatus 100. In addition, the sound pickup device C 500 (a second sound pickup device) is a device used by the second subject person 902 (a third user) described below with reference to FIG. 9, who is located within the predetermined range centered on the image pickup apparatus 100.

The reproducing device B 300 (a first reproducing device) is a receiver of the Auracast™, which is used by the first subject person 901 (the second user). In addition, the reproducing device C 600 (a second reproducing device) is a receiver of the Auracast™, which is used by the second subject person 902 (the third user). Although not shown in FIG. 2, the reproducing device B 300 and the reproducing device C 600 each include a CPU that performs overall control, a read only memory (a ROM) that stores programs for performing the overall control, a main switch that turns a main power supply on and off, etc.

The reproduction information selecting apparatus B 400 and the reproduction information selecting apparatus C 700 are each an assistant of the Auracast™, which is located within the predetermined range centered on the image pickup apparatus 100, and are each an information processing apparatus according to the present embodiment. Although not shown in FIG. 2, the reproduction information selecting apparatus B 400 and the reproduction information selecting apparatus C 700 each include a CPU that performs overall control, a ROM that stores programs for performing the overall control, a main switch that turns a main power supply on and off, etc.

The image pickup apparatus 100 is delivering audio data and advertisements of the Auracast™ to an unspecified number of wireless devices located within the predetermined range centered on the image pickup apparatus 100. In addition, the reproducing device B 300 and the reproducing device C 600 are receiving the audio data of the Auracast™ delivered from the image pickup apparatus 100, respectively, and the reproduction information selecting apparatus B 400 and the reproduction information selecting apparatus C 700 are receiving the advertisements of the Auracast™ delivered from the image pickup apparatus 100, respectively.

In the Auracast™, the receiver and the advertisement are treated as a pair, and the receiver and the assistant are connected to each other by Unicast communication. Therefore, the user of the receiver and the user of the assistant are able to refer to a plurality of advertisements that have been received by the assistant from the transmitter and select the audio data (a channel of the audio data) that the receiver will receive. In addition, a device becoming the receiver may include the function of the assistant.

The image pickup apparatus 100 receives, via the wireless unit A 109 (see FIG. 1), an audio signal transmitted from the sound pickup device B 200 by Unicast communication. Similarly, the image pickup apparatus 100 receives, via the wireless unit A 109 (see FIG. 1), an audio signal transmitted from the sound pickup device C 500 by Unicast communication.

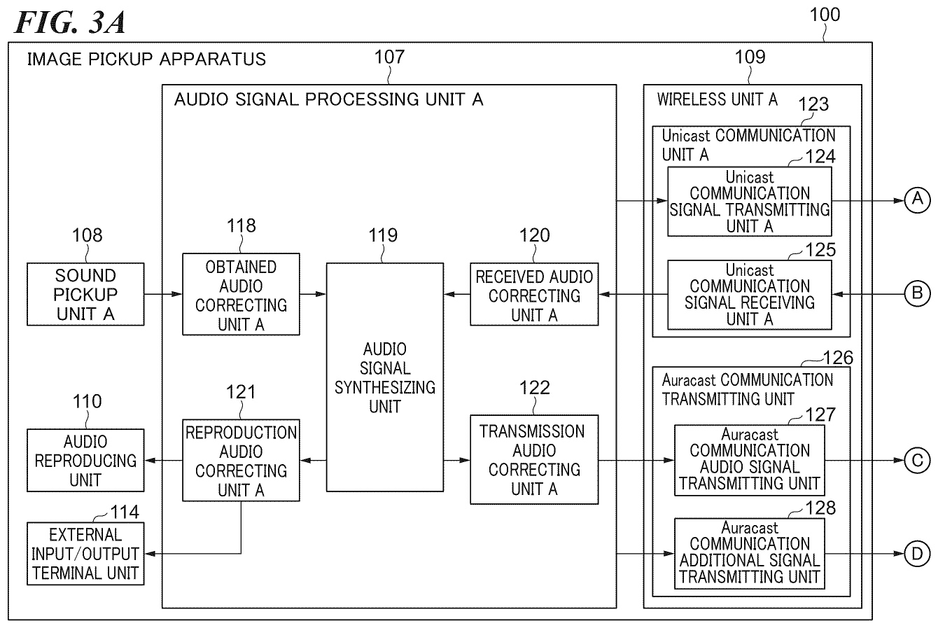

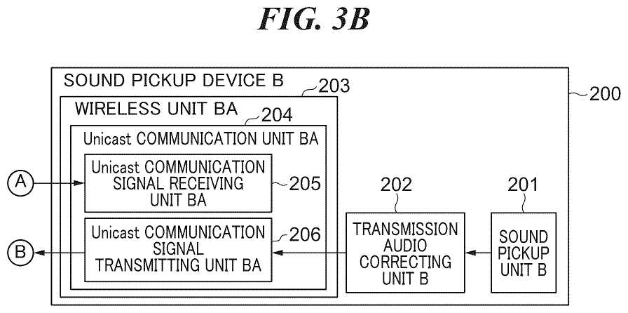

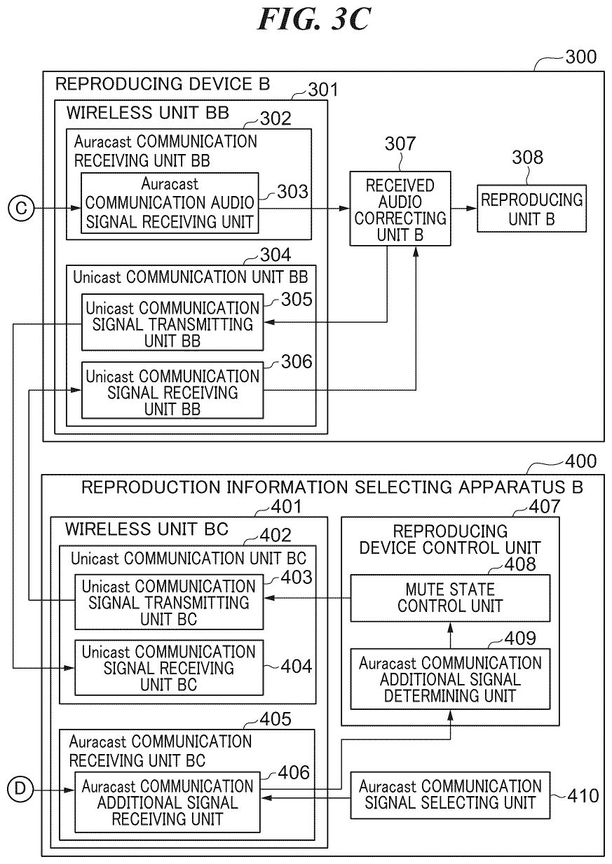

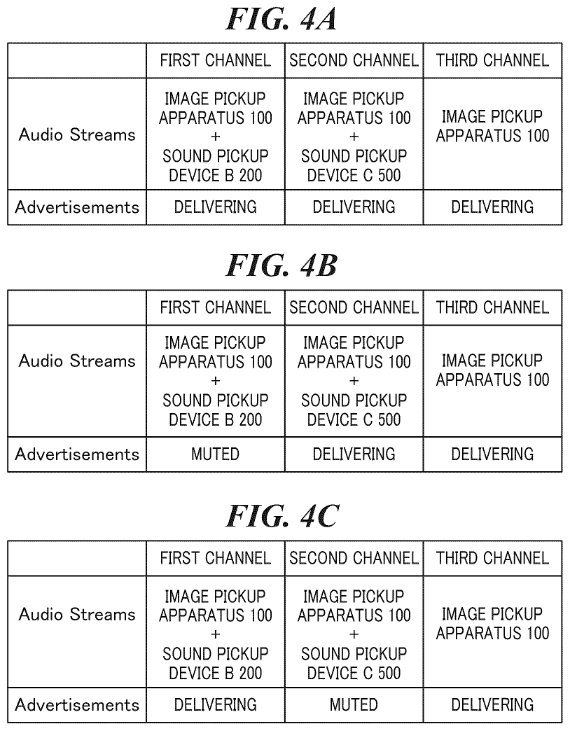

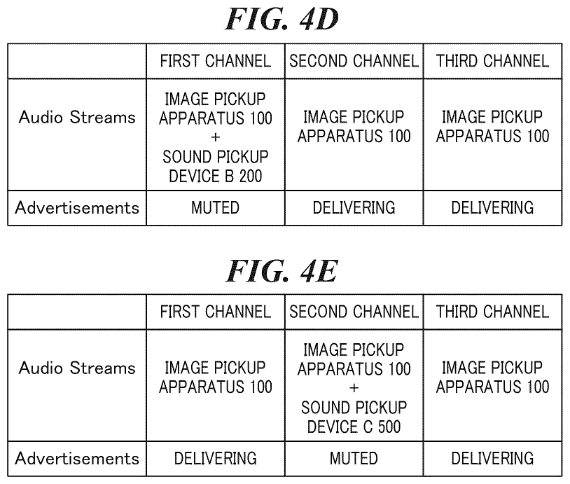

In the image pickup apparatus 100, the audio signal received from the sound pickup device B 200 and the audio signal received from the sound pickup device C 500 are subjected to a synthesis processing by an audio signal synthesizing unit 119 that will be described below (see FIG. 3A) of the audio signal processing unit A 107 to generate audio data. It should be noted that in FIG. 2, the wireless unit A 109 of the image pickup apparatus 100 receives the audio signals by Unicast communication from two devices, the sound pickup device B 200 and the sound pickup device C 500, but the wireless unit A 109 of the image pickup apparatus 100 may receive audio signals by Unicast communication from other sound pickup devices that are not shown in FIG. 2. Specifically, a Unicast communication signal receiving unit A 125 that will be described below (see FIG. 3A) of the wireless unit A 109 may be connectable to three or more sound pickup devices, and may be connectable to other sound pickup devices besides the sound pickup device B 200 and the sound pickup device C 500. In addition, since the number of the received audio signals to be used to generate audio data increases, the number of channels for the audio data generated and delivered by the image pickup apparatus 100, which is the transmitter, may be increased. It should be noted that the channels for the audio data (the channels of the audio data) generated and delivered by the image pickup apparatus 100, which is the transmitter, will be described below with reference to FIG. 4A, FIG. 4B, FIG. 4C, FIG. 4D, and FIG. 4E.

It should be noted that in FIG. 2, the reproducing device B 300 and the sound pickup device B 200 are configured separately, but the reproducing device B 300 may be configured to include the sound pickup device B 200.

FIG. 3A is a block diagram that illustrates a wireless connection configuration and an audio communication configuration of the image pickup apparatus 100, and FIG. 3B is a block diagram that illustrates the details of a hardware configuration of the sound pickup device B 200. FIG. 3C is a block diagram that illustrates a hardware configuration of the reproducing device B 300 and a hardware configuration of the reproduction information selecting apparatus B 400. It should be noted that since the sound pickup device B 200, the reproducing device B 300, and the reproduction information selecting apparatus B 400 that are shown in FIG. 2 have the same device/apparatus configuration as the sound pickup device C 500, the reproducing device C 600, and the reproduction information selecting apparatus C 700 that are shown in FIG. 2, respectively, duplicated descriptions will be omitted.

Therefore, in the following description of FIG. 3A and FIG. 3B, the connection configuration of the audio processing system 1 will be described assuming that there is one device becoming the sound pickup device, one device becoming the transmitter, one device becoming the receiver, and one device becoming the assistant.

FIG. 3A is a block diagram that illustrates a detailed configuration of the audio signal processing unit A 107 and the wireless unit A 109 of the image pickup apparatus 100 that includes the function of the transmitter of the Auracast™.

As shown in FIG. 3A, the audio signal processing unit A 107 includes an obtained audio correcting unit A 118, the audio signal synthesizing unit 119, a received audio correcting unit A 120, a reproduction audio correcting unit A 121, and a transmission audio correcting unit A 122.

The obtained audio correcting unit A 118 is a block that corrects the audio signal captured by the sound pickup unit A 108, and the audio signal synthesizing unit 119 includes a block that performs the synthesis processing with respect to the audio signal that has been corrected by the obtained audio correcting unit A 118.

The obtained audio correcting unit A 118 corrects a sound pressure, frequency characteristics, etc. of the audio signal output from the sound pickup unit A 108 and outputs the corrected audio signal to the audio signal synthesizing unit 119. The photographer is able to adjust the obtained audio correcting unit A 118 to correct the monitoring sound (the monitoring audio) that the photographer himself/herself hears and the audio (the sound) heard by the subject receiving the audio data.

The reproduction audio correcting unit A 121 corrects a sound pressure, frequency characteristics, etc. of a reproduction audio signal that has been processed by the audio signal synthesizing unit 119 and outputs the corrected reproduction audio signal to the audio reproducing unit 110 and the external input/output terminal unit 114.

As shown in FIG. 3A, the wireless unit A 109 includes a Unicast communication unit A 123 and an Auracast communication transmitting unit 126.

The Unicast communication unit A 123 is configured to include a Unicast communication signal transmitting unit A 124 and the Unicast communication signal receiving unit A 125.

The Unicast communication signal transmitting unit A 124 transmits a Unicast communication signal to a wireless device to be paired, in the present embodiment, to a Unicast communication signal receiving unit BA 205 shown in FIG. 3B, which will be described below.

The Unicast communication signal receiving unit A 125 receives a Unicast communication signal from a wireless device to be paired, in the present embodiment, from a Unicast communication signal transmitting unit BA 206 shown in FIG. 3B, which will be described below.

FIG. 3B is a block diagram that illustrates a detailed configuration of the sound pickup device B 200, and FIG. 3C is a block diagram that illustrates a detailed configuration of the reproducing device B 300 and a detailed configuration of the reproduction information selecting apparatus B 400.

As shown in FIG. 3B, in addition to the sound pickup unit B 201, the sound pickup device B 200 includes a transmission audio correcting unit B 202 and a wireless unit BA 203.

The wireless unit BA 203 includes a Unicast communication unit BA 204 having the same configuration as the above-described Unicast communication unit A 123. The Unicast communication unit BA 204 includes the Unicast communication signal transmitting unit BA 206 having the same configuration as the above-described Unicast communication signal transmitting unit A 124, and the Unicast communication signal receiving unit BA 205 having the same configuration as the above-described Unicast communication signal receiving unit A 125.

The sound pickup unit B 201 is an audio input unit that includes a microphone, and the sound pickup unit B 201 obtains the voice of the first subject person 901 who uses the sound pickup device B 200 as an audio signal (a second audio signal), converts the audio signal into an electrical signal, and then converts the electrical signal further into a digital signal and outputs the digital signal. It should be noted that the sound pickup unit C 501 shown in FIG. 2 is a device having the same configuration as the sound pickup unit B 201, and the sound pickup unit C 501 obtains the voice of the second subject person 902 who uses the sound pickup device C 500 as an audio signal (a third audio signal), converts the audio signal into an electrical signal, and then converts the electrical signal further into a digital signal and outputs the digital signal.

The transmission audio correcting unit B 202 corrects a sound pressure, frequency characteristics, etc. of an audio signal output by the sound pickup unit B 201 and outputs the corrected audio signal to the Unicast communication signal transmitting unit BA 206.

As described above, the audio (the sound) obtained by the sound pickup unit B 201 of the sound pickup device B 200 is transmitted by the Unicast communication signal transmitting unit BA 206 to the Unicast communication signal receiving unit A 125 of the image pickup apparatus 100, and the photographer is able to listen to the audio signal obtained by the sound pickup device B 200.

Returning to FIG. 3A, the received audio correcting unit A 120 corrects a sound pressure, frequency characteristics, etc. of the audio signal received by the Unicast communication signal receiving unit A 125 and outputs the corrected audio signal to the audio signal synthesizing unit 119.

The audio signal synthesizing unit 119 performs the synthesis processing with respect to the audio signal obtained from the obtained audio correcting unit A 118 and the audio signal obtained from the received audio correcting unit A 120. Here, the number of connected wireless devices that are capable of being paired with the Unicast communication unit A 123 may be plural, and the received audio correcting unit A 120 is also capable of being adapted in accordance with the number of the connected wireless devices. Therefore, a plurality of audio signals may be input to the audio signal synthesizing unit 119. The audio signal obtained by the synthesis processing performed by the audio signal synthesizing unit 119 is generated as audio data for the transmitter of the Auracast™ and is delivered to an unspecified number of wireless devices from an Auracast communication audio signal transmitting unit 127 that will be described below of the Auracast communication transmitting unit 126. Since delivering of the audio data is performed by an isochronous transfer method (hereinafter, referred to as “an isochronous method”), the audio data generated after the synthesis processing performed by the audio signal synthesizing unit 119 is capable of being delivered to a plurality of channels. The channels for the audio data (the channels of the audio data) will be described below with reference to FIG. 4A, FIG. 4B, FIG. 4C, FIG. 4D, and FIG. 4E.

The transmission audio correcting unit A 122 corrects a sound pressure, frequency characteristics, etc. of a reproduction audio signal that has been processed by the audio signal synthesizing unit 119 and outputs the corrected reproduction audio signal to the Auracast communication audio signal transmitting unit 127 that will be described below of the Auracast communication transmitting unit 126.

The Auracast communication transmitting unit 126 is a wireless module for the transmitter of the Auracast™, and is configured to include the Auracast communication audio signal transmitting unit 127 and an Auracast communication additional signal transmitting unit 128.

The Auracast communication audio signal transmitting unit 127 (a first wireless delivering unit serving as a first wireless delivering means) performs transmission of audio data, which is included in data to be transmitted by the transmitter of the Auracast™, with respect to an unspecified number of devices.

The Auracast communication additional signal transmitting unit 128 (a second wireless delivering unit serving as a second wireless delivering means) performs transmission of an advertisement, which is included in the data to be transmitted by the transmitter of the Auracast™, with respect to the unspecified number of devices. Here, the advertisement is additional information associated with each channel, and includes information about a mute setting of the audio data of each channel. The information about the mute setting manages, as a status, whether the audio data of each channel being transmitted is “delivering” or “muted”. It is possible for the user to decide, by using the operation unit 111 that has been described above, whether each channel of the audio data is “delivering” or “muted”.

In addition, the audio data transmitted from the Auracast communication audio signal transmitting unit 127 may be changed in accordance with the result of a decision made by the user by using the operation unit 111 that has been described above.

As shown in FIG. 3C, the reproducing device B 300 is a device assigned to the receiver of the Auracast™, and includes a wireless unit BB 301, a received audio correcting unit B 307, and a reproducing unit B 308.

The wireless unit BB 301 includes an Auracast communication receiving unit BB 302 and a Unicast communication unit BB 304.

The Auracast communication receiving unit BB 302 is a module for the receiver of the Auracast™, which is included in the reproducing device B 300, and includes an Auracast communication audio signal receiving unit 303.

The Auracast communication audio signal receiving unit 303 receives audio data of a channel designated by the reproduction information selecting apparatus B 400 from among the audio data delivered by the Auracast communication audio signal transmitting unit 127 (see FIG. 3A), and outputs, to the received audio correcting unit B 307, the audio data of the channel designated by the reproduction information selecting apparatus B 400, which has been received. The reproduction information selecting apparatus B 400 will be described below.

The received audio correcting unit B307 corrects a sound pressure, frequency characteristics, etc. of the audio signal output from the Auracast communication audio signal receiving unit 303 and outputs the corrected audio signal to the reproducing unit B 308.

The reproducing unit B 308 reproduces the audio signal that has been corrected by the received audio correcting unit B 307.

As described above, the person who is the subject is able to listen to the audio signal transmitted from the image pickup apparatus 100 by using the reproducing device B 300.

The unicast communication unit BB 304 is configured to include a Unicast communication signal transmitting unit BB 305 and a Unicast communication signal receiving unit BB 306.

The Unicast communication signal transmitting unit BB 305 transmits a Unicast communication signal to a wireless device to be paired, in the present embodiment, to a Unicast communication signal receiving unit BC 404 (see FIG. 3C) that will be described below.

The Unicast communication signal receiving unit BB 306 transmits and receives a Unicast communication signal from a wireless device to be paired, in the present embodiment, from a Unicast communication signal transmitting unit BC 403 (see FIG. 3C) that will be described below.

As shown in FIG. 3C, the reproduction information selecting apparatus B 400 is an apparatus assigned to the assistant of the Auracast™, and includes a wireless unit BC 401, a reproducing device control unit 407, and an Auracast communication signal selecting unit 410.

The Auracast communication signal selecting unit 410 decides the channel of the audio data adopting the isochronous method delivered by the Auracast communication audio signal transmitting unit 127 (FIG. 3A) based on the operator's selection.

The wireless unit BC 401 includes a Unicast communication unit BC 402 having the same configuration as the above-described Unicast communication unit BB 304, and an Auracast communication receiving unit BC 405 having the same configuration as the above-described Auracast communication receiving unit BB 302.

The Unicast communication unit BC 402 (a first wireless communication unit serving as a first wireless communication means) is paired with the Unicast communication unit BB 304 of the reproducing device B 300 by using wireless communication. The Unicast communication unit BC 402 is configured to include the Unicast communication signal transmitting unit BC 403 and the Unicast communication signal receiving unit BC 404.

The Auracast communication receiving unit BC 405 (a second wireless communication unit serving as a second wireless communication means) is a module for the assistant of the Auracast™, and includes an Auracast communication additional signal receiving unit 406.

The Auracast communication additional signal receiving unit 406 receives the advertisement delivered by the Auracast communication additional signal transmitting unit 128 (see FIG. 3A), and outputs the received advertisement to an Auracast communication additional signal determining unit 409 that will be described below of the reproducing device control unit 407.

The reproducing device control unit 407 is a block that controls the reproducing device B 300 based on the advertisement that has been received by the Auracast communication additional signal receiving unit 406, and is configured to include the Auracast communication additional signal determining unit 409 and a mute state control unit 408.

The Auracast communication additional signal determining unit 409 obtains a mute setting of the channel that has been decided by the Auracast communication signal selecting unit 410 from among the advertisement that has been received by the Auracast communication additional signal receiving unit 406. Next, the Auracast communication additional signal determining unit 409 determines whether the status of the obtained mute setting is “delivering” or “muted”.

The mute state control unit 408 switches the control of the Unicast communication signal transmitting unit BC 403 in accordance with the status of the mute setting that has been determined by the Auracast communication additional signal determining unit 409. Specifically, in the case where the status of the mute setting is “muted”, the mute state control unit 408 controls the Unicast communication signal transmitting unit BC 403 to transmit a mute instruction. This mute instruction is transmitted from the Unicast communication signal transmitting unit BC 403 to the received audio correcting unit B 307 via the Unicast communication signal receiving unit BB 306. Upon receiving this mute instruction, the received audio correcting unit B 307 stops outputting the audio signal to the reproducing unit B 308, and reproduction of the audio signal by the reproducing unit B 308 of the reproducing device B 300 is muted (stopped).

Therefore, depending on the status of the mute setting of each channel of the audio data, which has been decided by the user of the image pickup apparatus 100, whether or not the reproduction of the audio signal by the reproducing unit B 308 of the reproducing device B 300 is muted is decided.

FIG. 4A, FIG. 4B, FIG. 4C, FIG. 4D, and FIG. 4E are diagrams that illustrate the contents of audio data and advertisements delivered by the image pickup apparatus 100, which serves as the transmitter. Here, in FIG. 4A, FIG. 4B, FIG. 4C, FIG. 4D, and FIG. 4E, “Audio Streams” indicates the audio data, and “Advertisements” indicate the advertisement.

In FIG. 4A, FIG. 4B, and FIG. 4C, a control will be described in which, when the photographer changes the status of the mute setting of the advertisement for one channel from among the channels by using the operation unit 111 of the image pickup apparatus 100, the audio data for the one channel is not changed. In addition, in FIG. 4D, and FIG. 4E, a control will be described in which, when the photographer changes the status of the mute setting of the advertisement for one channel from among the channels by using the operation unit 111, both the audio data and the advertisement for the one channel are changed.

FIG. 4A, FIG. 4B, and FIG. 4C each show a case where the photographer changes the status of the mute setting of the advertisement for one different channel by using the operation unit 111 of the image pickup apparatus 100.

As described above, the audio data is common to all of FIG. 4A, FIG. 4B, and FIG. 4C.

In a first channel, audio data generated by synthesizing the audio signal from the sound pickup unit A 108 in the image pickup apparatus 100 and the audio signal from the sound pickup unit B 201 in the sound pickup device B 200 is delivered.

In a second channel, audio data generated by synthesizing the audio signal from the sound pickup unit A 108 in the image pickup apparatus 100 and the audio signal from the sound pickup unit C 501 in the sound pickup device C 500 is delivered.

In a third channel, audio data that has not been subjected to the synthesis processing with other audio signals and that is generated solely from the audio signal from the sound pickup unit A 108 in the image pickup apparatus 100 is delivered.

In FIG. 4A, FIG. 4B, and FIG. 4C, the advertisement for each channel changes in accordance with the result of the decision made by the photographer by using the image pickup unit 104 in the image pickup apparatus 100.

In FIG. 4A, the photographer has decided to deliver all channels (the first channel, the second channel, and the third channel). Therefore, the status of the mute setting of the advertisement has been decided to be “delivering” for all channels.

In FIG. 4B, the photographer has decided to mute the first channel and deliver the remaining channels (the second channel and the third channel). Therefore, the status of the mute setting of the advertisement has been decided to be “muted” only for the first channel, and be “delivering” for the remaining channels (the second channel and the third channel). As described with reference to FIG. 2, in the case where the status of the mute setting of the advertisement is “muted”, the assistant is controlled to mute the transmission and reception of the audio signal with respect to the receiver. Therefore, the audio signal transmitted and received by the receiver that has been selected to receive the audio data of the first channel is mute-processed.

In FIG. 4C, the photographer has decided to mute the second channel and deliver the remaining channels (the first channel and the third channel). Therefore, the status of the mute setting of the advertisement has been decided to be “muted” only for the second channel, and be “delivering” for the remaining channels (the first channel and the third channel). As described above, in the case where the status of the mute setting of the advertisement is “muted”, the assistant is controlled to mute the transmission and reception of the audio signal with respect to the receiver. Therefore, the audio signal transmitted and received by the receiver that is receiving the audio data of the second channel is mute-processed.

Next, the control for, when changing the status of the mute setting of the advertisement which has been decided by the operation unit 111, also changing the audio data accordingly will be described with reference to FIG. 4D and FIG. 4E.

In both FIG. 4D and FIG. 4E, for a channel that the photographer has decided to mute, the voice of a person who uses a receiver that the channel is being selected is controlled so that a person who uses a receiver that a channel other than the channel that the photographer has decided to mute is being selected is not capable of hearing the voice.

As a premise, it is assumed that a person using the sound pickup device B 200 and a person using the reproducing device B 300 are the same person (hereinafter, referred to as “a person B”), and that a person using the sound pickup device C 500 and a person using the reproducing device C 600 are the same person (hereinafter, referred to as “a person C”). It should be noted that the sound pickup device B 200 and the reproducing device B 300 may be the same device, and the sound pickup device C 500 and the reproducing device C 600 may be the same device.

In FIG. 4D, the photographer has decided to mute the first channel and deliver the remaining channels (the second channel and the third channel). Therefore, the audio data of the channel from among the respective channels shown in FIG. 4A where the status of the mute setting is “delivering” and audio data generated by synthesizing the audio signal other than the audio signal of the sound pickup unit A 108 in the image pickup apparatus 100 is delivered is changed. In the case of FIG. 4D, the channel, for which the audio data is to be changed, is the second channel, and the audio data to be delivered is changed from the synthesized audio data shown in FIG. 4A to the audio data that is generated solely from the audio signal from the sound pickup unit A 108 in the image pickup apparatus 100.

In this way, in the case of the setting of FIG. 4A, it is assumed that person C uses the reproducing device C 600 via the first channel to listen to not only instructions from the photographer but also audio interaction between the person B and the photographer. Similarly, it is assumed that person B uses the reproducing device B 300 via the second channel to listen to not only instructions from the photographer but also audio interaction between person C and the photographer. In this case, if the photographer mutes the first channel and stops the audio interaction with person C, the voice of person C is capable of being controlled so that person B, who performs the audio interaction with the photographer via the second channel, is also not capable of hearing the voice of person C.

In FIG. 4D, the status of the mute setting of the advertisement has been decided to be “muted” for the first channel. As described with reference to FIG. 2, in the case where the status of the mute setting of the advertisement is “muted”, the assistant is controlled to mute the transmission and reception of the audio signal with respect to the receiver. Therefore, the audio signal transmitted and received by the receiver that the first channel is being selected is mute-processed. Furthermore, the audio of the sound pickup device C 500, which is also used by the person who uses the receiver that the first channel is being selected, is corrected so that the audio of the sound pickup device C 500 is not synthesized by the audio signal synthesizing unit 119. As a result, the audio data of the remaining channels that are “delivering”, which is transmitted from the Auracast communication audio signal transmitting unit 127, will be only the audio data of the image pickup apparatus 100. As a result, by muting the first channel, it becomes possible to communicate only with the person who is receiving the second channel.

In FIG. 4E, the photographer has decided to mute the second channel and deliver the remaining channels (the first channel and the third channel). Therefore, the audio data of the channel from among the respective channels shown in FIG. 4A where the status of the mute setting is “delivering” and audio data generated by synthesizing the audio signal other than the audio signal of the sound pickup unit A 108 in the image pickup apparatus 100 is delivered is changed. In the case of FIG. 4E, the channel, for which the audio data is to be changed, is the first channel, and the audio data to be delivered is changed from the synthesized audio data shown in FIG. 4A to the audio data that is generated solely from the audio signal from the sound pickup unit A 108 in the image pickup apparatus 100.

In this way, in the case of the setting of FIG. 4A, it is assumed that person B uses the reproducing device B 300 via the second channel to listen to not only instructions from the photographer but also audio interaction between the person C and the photographer. Similarly, it is assumed that person C uses the reproducing device C 600 via the first channel to listen to not only instructions from the photographer but also audio interaction between the person B and the photographer. In this case, if the photographer mutes the second channel and stops the audio interaction with person B, the voice of person B is capable of being controlled so that person C, who performs the audio interaction with the photographer via the first channel, is also not capable of hearing the voice of person B.

In FIG. 4E, the status of the mute setting of the advertisement has been decided to be “muted” for the second channel. As described with reference to FIG. 2, in the case where the status of the mute setting of the advertisement is “muted”, the assistant is controlled to mute the transmission and reception of the audio signal with respect to the receiver. Therefore, the audio signal transmitted and received by the receiver that the second channel is being selected is mute-processed. Furthermore, the audio of the sound pickup device B 200, which is also used by the person who uses the receiver that the second channel is being selected, is corrected so that the audio of the sound pickup device B 200 is not synthesized by the audio signal synthesizing unit 119. As a result, the audio data of the remaining channels that are “delivering”, which is transmitted from the Auracast communication audio signal transmitting unit 127, will be only the audio data of the image pickup apparatus 100. As a result, by muting the second channel, it becomes possible to communicate only with the person who is receiving the first channel.

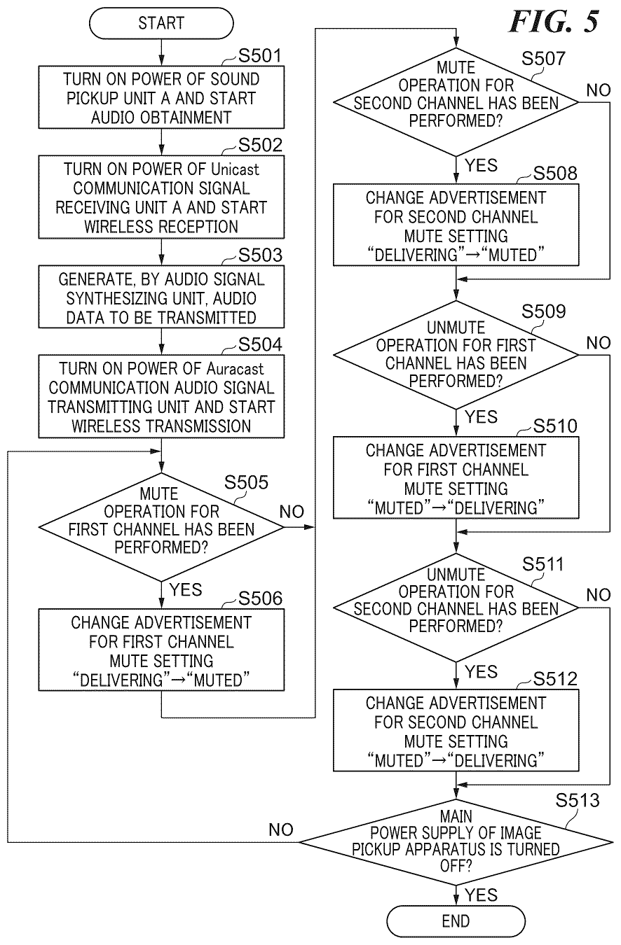

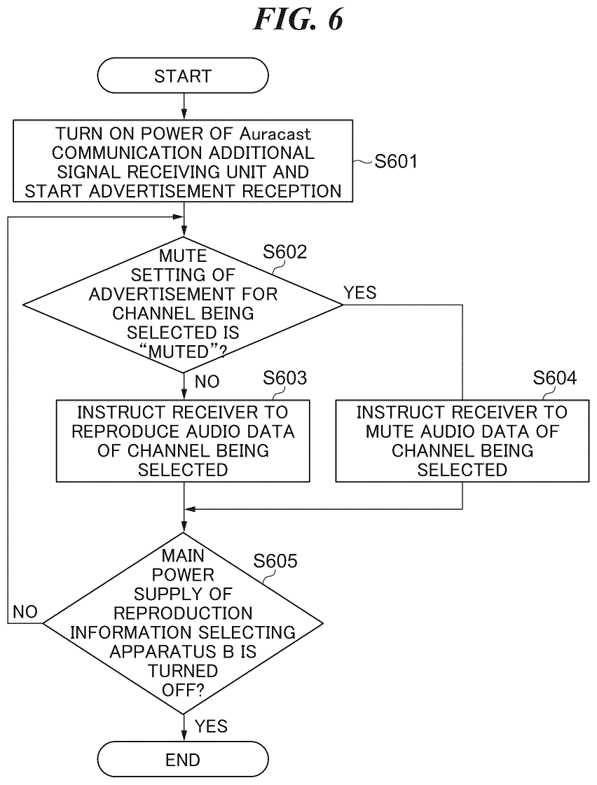

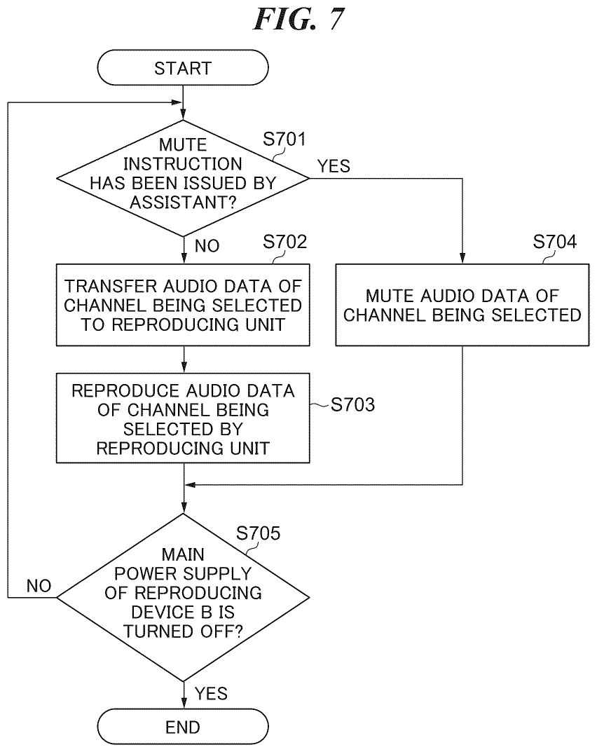

Next, the operations of the image pickup apparatus 100, the reproducing device B 300, and the reproducing device C 600 will be described with reference to FIG. 5, FIG. 6, and FIG. 7.

FIG. 5 is a flowchart of an audio mute control processing executed by the image pickup apparatus 100.

The audio mute control processing shown in FIG. 5 is executed by the central control unit 101 reading out a program from the storage unit 112.

As shown in FIG. 5, in a step S501, a power supply of the sound pickup unit A 108 is turned on, reception of the audio signal output from the sound pickup unit A 108 (audio obtainment) is started, and the audio mute control processing shown in FIG. 5 proceeds to a step S502. The received audio signal is input to the audio signal synthesizing unit 119.

In step S502, a power supply of the Unicast communication signal receiving unit A 125 is turned on, and a connection with the reproducing device B 300 is started. After the Unicast communication connection is established, wireless reception of the audio signals that have been obtained by the sound pickup unit B 201 of the sound pickup device B 200 and the sound pickup unit C 501 of the sound pickup device C 500 is started, and the audio mute control processing shown in FIG. 5 proceeds to a step S503.

In step S503, the audio signal synthesizing unit 119 starts generating audio data for the first channel, the second channel, and the third channel. The audio signal synthesizing unit 119 generates the audio data for each channel (the audio data of each channel) based on the audio signal of the sound pickup unit A 108 that has been received in the step S501, and the audio signals of the sound pickup device B 200 and the sound pickup device C 500 that have been received by the Unicast communication signal receiving unit A 125 in the step S502. Here, for example, as shown in FIG. 4A, the audio data is generated for each channel. Then, the audio mute control processing shown in FIG. 5 proceeds to a step S504.

In step S504, a power supply of the Auracast communication audio signal transmitting unit 127 is turned on. Thereafter, when delivering the audio data of each channel generated in step S503 and its advertisement is started and a mute setting screen 1000 shown in FIG. 10 is displayed on the display unit 113, the audio mute control processing shown in FIG. 5 proceeds to a step S505.

FIG. 10 is a diagram that illustrates the mute setting screen 1000 displayed on the display unit 113 shown in FIG. 1.

As shown in FIG. 10, the mute setting screen 1000 displays a channel name, audio being delivered, and a mute setting.

The channel name is the name of each channel through which the audio data is delivered from the image pickup apparatus 100, which is the transmitter.

The audio being delivered indicates the audio to be delivered on each channel.

The mute setting includes icons 1001 to 1003 that each indicate the status of the mute setting for each channel.

The icon 1001 is an icon indicating the status of the mute setting of the first channel. In FIG. 10, the icon 1001 shows a case where the status of the mute setting of the first channel is in an OFF state, that is, a case where the first channel is “delivering”. The photographer is able to issue a mute instruction that sets the status of the mute setting of the first channel to an ON state (“muted”) by performing an operation to slide a slide button of the icon 1001 to the right side of FIG. 10 (a mute operation).

The icon 1002 is an icon indicating the status of the mute setting of the second channel. In FIG. 10, the icon 1002 shows a case where the status of the mute setting of the second channel is in the ON state, that is, a case where the second channel is “muted”. The photographer is able to issue an instruction that sets the status of the mute setting of the second channel to the OFF state (“delivering”), that is, an instruction to unmute, by performing an operation to slide a slide button of the icon 1002 to the left side of FIG. 10 (an unmute operation).

The icon 1003 is an icon indicating the status of the mute setting of the third channel. In FIG. 10, the icon 1003 shows a case where the status of the mute setting of the third channel is in the ON state, that is, a case where the third channel is “muted”. The photographer is able to issue an instruction that sets the status of the mute setting of the third channel to the OFF state (“delivering”), that is, an instruction to unmute, by performing an operation to slide a slide button of the icon 1003 to the left side of FIG. 10 (an unmute operation).

It should be noted that in the present embodiment, the case where the status of the mute setting of the first channel, the status of the mute setting of the second channel, and the status of the mute setting of the third channel are all set to the OFF state (“delivering”) in the step S504 will be described.

Returning to FIG. 5, in step S505, it is detected whether or not a mute operation for the first channel has been performed by the photographer.

In the case where a mute operation for the first channel has been performed (YES in step S505), the audio mute control processing shown in FIG. 5 proceeds to a step S506. On the other hand, in the case where a mute operation for the first channel has not been performed (NO in step S505), the audio mute control processing shown in FIG. 5 proceeds to a step S507.

In step S506, a change is made to the delivering of the advertisement being transmitted from the Auracast communication audio signal transmitting unit 127. Specifically, the status of the mute setting of the first channel is switched from “delivering” to “muted”, and the audio mute control processing shown in FIG. 5 proceeds to the step S507.

In step S507, it is detected whether or not a mute operation for the second channel has been performed by the photographer.

In the case where a mute operation for the second channel has been performed (YES in step S507), the audio mute control processing shown in FIG. 5 proceeds to a step S508. On the other hand, in the case where a mute operation for the second channel has not been performed (NO in the step S507), the audio mute control processing shown in FIG. 5 proceeds to a step S509.

In step S508, a change is made to the delivering of the advertisement being transmitted from the Auracast communication audio signal transmitting unit 127. Specifically, the status of the mute setting of the second channel is switched from “delivering” to “muted”, and the audio mute control processing shown in FIG. 5 proceeds to the step S509.

In step S509, it is detected whether or not an unmute operation for the first channel has been performed by the photographer.

In the case where an unmute operation for the first channel has been performed (YES in step S509), the audio mute control processing shown in FIG. 5 proceeds to a step S510. On the other hand, in the case where an unmute operation for the first channel has not been performed (NO in step S509), the audio mute control processing shown in FIG. 5 proceeds to a step S511.

In step S510, a change is made to the delivering of the advertisement being transmitted from the Auracast communication audio signal transmitting unit 127. Specifically, the status of the mute setting of the first channel is switched from “muted” to “delivering”, and the audio mute control processing shown in FIG. 5 proceeds to the step S511.

In step S511, it is detected whether or not an unmute operation for the second channel has been performed by the photographer.

In the case where an unmute operation for the second channel has been performed (YES in step S511), the audio mute control processing shown in FIG. 5 proceeds to a step S512. On the other hand, in the case where an unmute operation for the second channel has not been performed (NO in step S511), the audio mute control processing shown in FIG. 5 proceeds to a step S513.

In step S512, a change is made to the delivering of the advertisement being transmitted from the Auracast communication audio signal transmitting unit 127. Specifically, the status of the mute setting of the second channel is switched from “muted” to “delivering”, and the audio mute control processing shown in FIG. 5 proceeds to the step S513.

In step S513, it is detected whether or not the main switch of the image pickup apparatus 100 has been operated and the main power supply of the image pickup apparatus 100 has been turned off. In the case where the main switch of the image pickup apparatus 100 has been operated and the main power supply of the image pickup apparatus 100 has been turned off (YES in step S513), the audio mute control processing shown in FIG. 5 ends. On the other hand, in the case where the main switch of the image pickup apparatus 100 has not been operated and the main power supply of the image pickup apparatus 100 remains being turned on (remains ON) (NO in the step S513), the audio mute control processing shown in FIG. 5 returns to step S505.

FIG. 6 is a flowchart of an audio mute control processing executed by the assistant. In the following, as an example, a case will be described in which the assistant is the reproduction information selecting apparatus B 400 used by a user B and the receiver is the reproducing device B 300 also used by user B. It should be noted that, also in a case where the assistant is the reproduction information selecting apparatus C 700 used by a user C and the receiver is the reproducing device C 600 also used by user C, the same audio mute control processing is executed.

The audio mute control processing shown in FIG. 6 is executed by the CPU of the reproduction information selecting apparatus B 400 reading out a program from the ROM of the reproduction information selecting apparatus B 400. It should be noted that it is assumed that before the audio mute control processing shown in FIG. 6 is started, user B has already selected one channel out of the audio data of the multiple channels to be delivered from the image pickup apparatus 100 by using a user interface (a UI) (not shown) of the reproduction information selecting apparatus B 400. In addition, the reproducing device B 300 is receiving, by the Auracast communication audio signal receiving unit 303, the audio data of the already-selected channel delivered from the image pickup apparatus 100.

As shown in FIG. 6, in a step S601, a power supply of the Auracast communication additional signal receiving unit 406 is turned on, reception of the advertisement from the image pickup apparatus 100 is started, and the audio mute control processing shown in FIG. 6 proceeds to a step S602.

In the step S602, the Auracast communication additional signal determining unit 409 detects whether the status of the mute setting in the advertisement of the channel being selected is “delivering” or “muted”. In the case where the status of the mute setting in the advertisement of the channel being selected is “delivering” (NO in the step S602), the audio mute control processing shown in FIG. 6 proceeds to a step S603. On the other hand, in the case where the status of the mute setting in the advertisement of the channel being selected is “muted” (YES in the step S602), the audio mute control processing shown in FIG. 6 proceeds to a step S604.

In step S603, the mute state control unit 408 issues, to the received audio correcting unit B 307 of the reproducing device B 300, a reproduction instruction to reproduce the audio data of the channel being selected, which is being received by the Auracast communication audio signal receiving unit 303, by the reproducing unit B 308. Then, the audio mute control processing shown in FIG. 6 proceeds to a step S605. It should be noted that the reproduction information selecting apparatus B 400 may be provided with a display device (not shown in FIG. 3C) and may display, on the display device, a message indicating that the audio signal to a headphone in use (the reproducing unit B 308) is being delivered.

In step S604, the mute state control unit 408 issues, to the received audio correcting unit B 307 of the reproducing device B 300 that is the receiver, a mute instruction to stop the reproduction by the reproducing unit B 308 of the audio data of the channel being selected, which is being received by the Auracast communication audio signal receiving unit 303. Then, the audio mute control processing shown in FIG. 6 proceeds to step S605. It should be noted that the display device of the reproduction information selecting apparatus B 400 may be configured to display information about the mute setting of the headphone in use (the reproducing unit B 308). In addition, in step S604, the sound pickup device B may also be instructed to stop (mute) the transmission of the audio data to the image pickup apparatus 100 by Unicast communication.

In step S605, it is detected whether or not the main switch of the reproduction information selecting apparatus B 400 has been operated and the main power supply of the reproduction information selecting apparatus B 400 has been turned off. In the case where the main switch of the reproduction information selecting apparatus B 400 has been operated and the main power supply of the reproduction information selecting apparatus B 400 has been turned off (YES in step S605), the audio mute control processing shown in FIG. 6 ends. On the other hand, in the case where the main switch of the reproduction information selecting apparatus B 400 has not been operated and the main power supply of the reproduction information selecting apparatus B 400 remains being turned on (remains ON) (NO in the step S605), the audio mute control processing shown in FIG. 6 returns to the step S602.

FIG. 7 is a flowchart of an audio mute control processing executed by the receiver. In the following, as an example, a case will be described in which the receiver is the reproducing device B 300 used by user B and the assistant is the reproduction information selecting apparatus B 400 also used by user B. It should be noted that, also in a case where the receiver is the reproducing device C 600 used by user C and the assistant is the reproduction information selecting apparatus C 700 also used by user C, the same audio mute control processing is executed.

The audio mute control processing shown in FIG. 7 is executed by the CPU of the reproducing device B 300 reading out a program from the ROM of the reproducing device B 300. It should be noted that before the audio mute control processing shown in FIG. 7 is started, user B has already selected one channel out of the audio data of the multiple channels to be delivered from the image pickup apparatus 100 by using the user interface (the UI) (not shown) of the reproduction information selecting apparatus B 400. In addition, the reproducing device B 300 is receiving, by the Auracast communication audio signal receiving unit 303, the audio data of the already-selected channel delivered from the image pickup apparatus 100.

As shown in FIG. 7, in a step S701, it is detected whether the mute instruction in step S604 or the reproduction instruction in step S603 has been issued from the reproduction information selecting apparatus B 400, which is the assistant. In the case where the reproduction instruction in step S603 has been issued from the reproduction information selecting apparatus B 400 (NO in step S701), the audio mute control processing shown in FIG. 7 proceeds to a step S702. On the other hand, in the case where the mute instruction in step S604 has been issued from the reproduction information selecting apparatus B 400 (YES in the step S701), the audio mute control processing shown in FIG. 7 proceeds to a step S704.

In step S702, in response to the reproduction instruction from the assistant, the audio data of the channel being selected, which is being received by the Auracast communication audio signal receiving unit 303, is transferred from the received audio correcting unit B 307 to the reproducing unit B 308, and then the audio mute control processing shown in FIG. 7 proceeds to a step S703.

In step S703, the audio data transferred from the received audio correcting unit B 307 to the reproducing unit B 308 is reproduced by the reproducing unit B 308, and then the audio mute control processing shown in FIG. 7 proceeds to a step S705.

In step S704, in response to the mute instruction from the assistant, the received audio correcting unit B 307 corrects the audio data of the channel being selected, which is being received by the Auracast communication audio signal receiving unit 303, so as to mute it, and then the audio mute control processing shown in FIG. 7 proceeds to step S705.

In step S705, it is detected whether or not the main switch of the reproducing device B 300 has been operated and the main power supply of the reproducing device B 300 has been turned off. In the case where the main switch of the reproducing device B 300 has been operated and the main power supply of the reproducing device B 300 has been turned off (YES in step S705), the audio mute control processing shown in FIG. 7 ends. On the other hand, in the case where the main switch of the reproducing device B 300 has not been operated and the main power supply of the reproducing device B 300 remains being turned on (remains ON) (NO in step S705), the audio mute control processing shown in FIG. 7 returns to step S701.

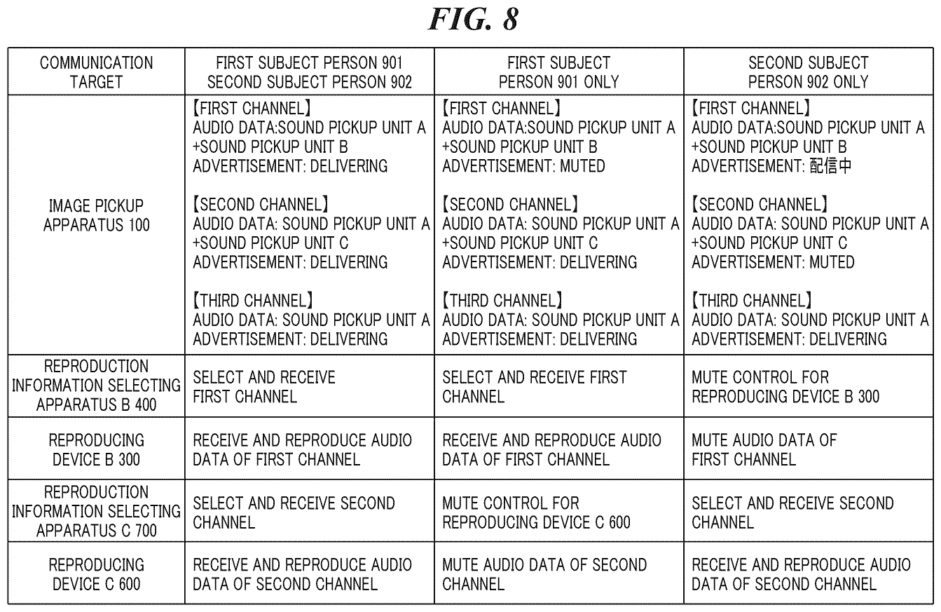

Next, the state of communication between the photographer and the subject in an actual photographing scene will be described with reference to FIG. 8 and FIG. 9.

FIG. 8 is a diagram for explaining audio mute control of the receiver and the assistant according to the state of the audio data and the advertisement for each channel delivered by the image pickup apparatus 100.

FIG. 9 is a diagram for illustrating an example of a scene in which the photographer 900 photographs a plurality of subjects at a distance. Here, the first subject person 901 and the second subject person 902, which are shown in FIG. 9 as the plurality of subjects, are both located within the predetermined range centered on the image pickup apparatus 100, but are located far enough away from the photographer 900 that oral communication with the photographer 900 is not possible.

In FIG. 8, as an example, the image pickup apparatus 100 serves as the transmitter, the reproducing device B 300 and the reproducing device C 600 serve as the receivers, and the reproduction information selecting apparatus B 400 and the reproduction information selecting apparatus C 700 serve as the assistants.

In addition, the photographer 900 is using the image pickup apparatus 100 to perform photographing of the first subject person 901 and the second subject person 902.

The first subject person 901 uses the reproducing device B 300 as the receiver and uses the reproduction information selecting apparatus B 400 as the assistant, and is receiving the audio data of the second channel delivered by the image pickup apparatus 100. In addition, the first subject person 901 wears the sound pickup device B 200 on himself/herself or has placed the sound pickup device B 200 nearby him/her.

The second subject person 902 uses the reproducing device C 600 as the receiver and uses the reproduction information selecting apparatus C 700 as the assistant, and is receiving the audio data of the first channel delivered by the image pickup apparatus 100. In addition, the second subject person 902 wears the sound pickup device C 500 on himself/herself or has placed the sound pickup device C 500 nearby him/her.

The image pickup apparatus 100 is performing delivering of the audio data through the first channel, the second channel, and the third channel by using the isochronous method.

In the first channel, the audio signal from the sound pickup unit A 108 of the image pickup apparatus 100 and the audio signal from the sound pickup unit B 201 of the sound pickup device B 200 are subjected to the synthesis processing and delivered as the audio data. In other words, the second subject person 902 who receives the first channel is in a state where he/she is able to hear the actual voices of the photographer 900 and the first subject person 901 through the audio signal reproduced by the reproducing device C 600.

In the second channel, the audio signal from the sound pickup unit A 108 of the image pickup apparatus 100 and the audio signal from the sound pickup unit C 501 of the sound pickup device C 500 are subjected to the synthesis processing and delivered as the audio data. In other words, the first subject person 901 who receives the second channel is in a state where he/she is able to hear the actual voices of the photographer 900 and the second subject person 902 through the audio signal reproduced by the reproducing device B 300.

In the third channel, the audio signal from the sound pickup unit A 108 of the image pickup apparatus 100 is delivered as the audio data without being subjected to the synthesis processing.

The photographer 900 is listening to output audio of the image pickup apparatus 100 by using a reproducing unit of a wired reproducing device (not shown) connected to the external input/output terminal unit 114. Here, the output audio is obtained by performing the synthesis processing with respect to the audio signal from the sound pickup unit A 108 of the image pickup apparatus 100, the audio signal from the sound pickup unit B 201 of the sound pickup device B 200, and the audio signal from the sound pickup unit C 501 of the sound pickup device C 500. In other words, the photographer 900 is in a state where he/she is able to hear the actual voices of the first subject person 901 and the second subject person 902.

In this way, the photographer 900, the first subject person 901, and the second subject person 902 are communicating with each other by using the sound pickup units (the microphones) and the reproducing units that are included in the respective devices owned by themself, and the Auracast™.

Among the advertisement transmitted by the image pickup apparatus 100, the status of the mute setting is updated in response to a mute operation or an unmute operation performed by the photographer 900 on the mute setting screen 1000 shown in FIG. 10. When the connection between the transmitter, the receiver, and the assistant is established, instructions regarding photographing issued by the photographer 900 are capable of being heard by the first subject person 901 and the second subject person 902. In other words, the status of the mute setting of the advertisement at this time is “delivering” for all the three channels.

In the case where the status of the mute setting of the first channel and the status of the mute setting of the second channel are both “delivering”, this is the state where the reproduction information selecting apparatus B 400 is issuing a reproduction instruction to the reproducing device B 300 and the reproduction information selecting apparatus C 700 is issuing a reproduction instruction to the reproducing device C 600. In other words, each of the reproducing device B 300 and the reproducing device C 600 is performing the reproduction of the audio data that has been received as the receiver.

Mute control in the case where the photographer 900 decides to issue instructions regarding photographing to only either the first subject person 901 or the second subject person 902 will be described.

In the case where the photographer 900 issues instructions regarding photographing to only the first subject person 901, the photographer 900 slides the slide button of the icon 1001 to the left side on the mute setting screen 1000 shown in FIG. 10. As a result, the status of the mute setting of the advertisement for the first channel is set to “muted”. The reproduction information selecting apparatus C 700, which has detected a change in the advertisement of the first channel, performs control with respect to the reproducing device C 600 so that the reproducing device C 600 stops (mutes) the reproduction of the audio data being received as the receiver. Therefore, the second subject person 902, who has been listening to the audio data of the first channel reproduced by the reproducing device C 600, is no longer able to hear the actual voices of the photographer 900 and the first subject person 901, as a result of the reproducing device C 600 being muted. As a result, communication is possible only between the photographer 900 and the first subject person 901.

Similarly, in the case where the photographer 900 issues instructions regarding photographing to only the second subject person 902, the photographer 900 slides the slide button of the icon 1002 to the left side on the mute setting screen 1000 shown in FIG. 10. As a result, the status of the mute setting of the advertisement for the second channel is set to “muted”. The reproduction information selecting apparatus B 400, which has detected a change in the advertisement of the second channel, performs control with respect to the reproducing device B 300 so that the reproducing device B 300 mutes the reproduction of the audio data being received as the receiver. Therefore, the first subject person 901, who has been listening to the audio data of the second channel reproduced by the reproducing device B 300, is no longer able to hear the actual voices of the photographer 900 and the second subject person 902, as a result of the reproducing device B 300 being muted. As a result, communication is possible only between the photographer 900 and the second subject person 902.

According to the present disclosure, the photographer is able to easily and individually communicate with the plurality of persons as the subjects at a distance by using a simple system configuration.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-032701, filed Mar. 3, 2025, which is hereby incorporated by reference herein in its entirety.

What is claimed is:

1. An audio processing apparatus used by a first user, the audio processing apparatus comprising:
an audio obtaining unit configured to obtain a voice of the first user as a first audio signal;
a first wireless receiving unit configured to receive, via wireless communication, from a first sound pickup device used by a second user located within a predetermined range centered on the audio processing apparatus, a voice of the second user, which is obtained as a second audio signal by the first sound pickup device;
a second wireless receiving unit configured to receive, via wireless communication, from a second sound pickup device used by a third user located within the predetermined range, a voice of the third user, which is obtained as a third audio signal by the second sound pickup device;
an audio signal processing unit configured to process the first audio signal, the second audio signal, and the third audio signal, and generate audio signals of a plurality of channels;
a first wireless delivering unit configured to deliver, via wireless communication, the audio signals of the plurality of channels, which have been generated by the audio signal processing unit, to a receiver located within the predetermined range;
a second wireless delivering unit configured to deliver additional information associated with each of the plurality of channels to an assistant that is located within the predetermined range and that transmits and receives signals to and from the receiver via wireless communication; and
a switching component configured to switch a mute setting of each of the plurality of channels between an ON state and an OFF state in response to a user operation by the first user, and
wherein the additional information includes information about the mute setting of the associated channel, and
in a case where the mute setting of a channel being selected by the receiver among the plurality of channels has been switched by the switching component, the information about the mute setting included in the additional information of the channel being selected by the receiver, which is delivered by the second wireless delivering unit, is changed to change a state of the receiver.

2. The audio processing apparatus according to claim 1, wherein
the second user has a first reproducing device nearby as a receiver that has selected a second channel among the plurality of channels,
the third user has a second reproducing device nearby as a receiver that has selected a first channel among the plurality of channels,
in accordance with information about a mute setting included in additional information of the second channel, control of reproducing and muting an audio signal of the second channel by the first reproducing device is performed, and
in accordance with information about a mute setting included in additional information of the first channel, control of reproducing and muting an audio signal of the first channel by the second reproducing device is performed.

3. The audio processing apparatus according to claim 2, wherein
the first channel is configured to deliver an audio signal obtained by performing a synthesis processing with respect to the first audio signal obtained from the audio obtaining unit and the second audio signal obtained from the first wireless receiving unit.

4. The audio processing apparatus according to claim 2, wherein
the second channel is configured to deliver an audio signal obtained by performing a synthesis processing with respect to the first audio signal obtained from the audio obtaining unit and the third audio signal obtained from the second wireless receiving unit.

5. The audio processing apparatus according to claim 2, wherein
when the additional information of the first channel is changed, the audio signal of the second channel is changed.

6. The audio processing apparatus according to claim 2, wherein
when the additional information of the second channel is changed, the audio signal of the first channel is changed.

7. An information processing apparatus used by a second user located within a predetermined range centered on an audio processing apparatus, the information processing apparatus comprising:
a first wireless communication unit configured to transmit and receive signals to and from a reproducing device, which is used by the second user and is located within the predetermined range, via wireless communication; and
a second wireless communication unit configured to receive, via wireless communication, additional information delivered by the audio processing apparatus, and
wherein the reproducing device is controlled by using the additional information received by the second wireless communication unit.

8. The information processing apparatus according to claim 7, wherein
the reproducing device is a receiver to which an audio signal is delivered from the audio processing apparatus, and
control of reproducing and muting the audio signal by the reproducing device is performed by using information about a mute setting of the audio signal included in the additional information.

9. The information processing apparatus according to claim 8, wherein
the information about the mute setting of the audio signal included in the additional information is displayed.

10. An audio processing system that comprises an audio processing apparatus used by a first user and an assistant located within a predetermined range centered on the audio processing apparatus,
wherein the audio processing apparatus comprises:
an audio obtaining unit configured to obtain a voice of the first user as a first audio signal;
a first wireless receiving unit configured to receive, via wireless communication, from a first sound pickup device used by a second user located within the predetermined range, a voice of the second user, which is obtained as a second audio signal by the first sound pickup device;
a second wireless receiving unit configured to receive, via wireless communication, from a second sound pickup device used by a third user located within the predetermined range, a voice of the third user, which is obtained as a third audio signal by the second sound pickup device;
an audio signal processing unit configured to process the first audio signal, the second audio signal, and the third audio signal, and generate audio signals of a plurality of channels;
a first wireless delivering unit configured to deliver, via wireless communication, the audio signals of the plurality of channels, which have been generated by the audio signal processing unit, to a receiver located within the predetermined range;
a second wireless delivering unit configured to deliver additional information associated with each of the plurality of channels to the assistant; and
a switching component configured to switch a mute setting of each of the plurality of channels between an ON state and an OFF state in response to a user operation by the first user,
wherein the additional information includes information about the mute setting of the associated channel, and
in a case where the mute setting of a channel being selected by the receiver among the plurality of channels has been switched by the switching component, the information about the mute setting included in the additional information of the channel being selected, which is delivered by the second wireless delivering unit, is changed to change a state of the receiver,
wherein an information processing apparatus, which is used by the second user and serves as the assistant, comprises:
a first wireless communication unit configured to transmit and receive signals to and from a reproducing device, which is used by the second user and serves as the receiver, via wireless communication; and
a second wireless communication unit configured to receive, via wireless communication, the additional information of the channel being selected, and
wherein the reproducing device is controlled by using the additional information of the channel being selected, which has been received by the second wireless communication unit.

11. A control method for an audio processing apparatus used by a first user, the control method comprising:
an audio obtaining step of obtaining a voice of the first user as a first audio signal;
a first wireless receiving step of receiving, via wireless communication, from a first sound pickup device used by a second user located within a predetermined range centered on the audio processing apparatus, a voice of the second user, which is obtained as a second audio signal by the first sound pickup device;
a second wireless receiving step of receiving, via wireless communication, from a second sound pickup device used by a third user located within the predetermined range, a voice of the third user, which is obtained as a third audio signal by the second sound pickup device;
an audio signal processing step of processing the first audio signal, the second audio signal, and the third audio signal, and generating an audio signal to be delivered through each of a plurality of channels;
a first wireless delivering step of delivering, via wireless communication, the audio signals of the plurality of channels, which have been generated in the audio signal processing step, to a receiver located within the predetermined range;
a second wireless delivering step of delivering additional information associated with each of the plurality of channels to an assistant that is located within the predetermined range and that transmits and receives signals to and from the receiver via wireless communication;
a switching step of switching a mute setting of each of the plurality of channels between an ON state and an OFF state in response to a user operation by the first user; and
a changing step, in which the additional information includes information about the mute setting of the associated channel, and in a case where the mute setting of a channel being selected by the receiver among the plurality of channels has been switched in the switching step, the information about the mute setting included in the additional information of the channel being selected by the receiver, which is delivered in the second wireless delivering step, is changed to change a state of the receiver.

12. A control method for an information processing apparatus used by a second user located within a predetermined range centered on an audio processing apparatus, the control method comprising:
a first wireless communication step of transmitting and receiving signals to and from a reproducing device, which is used by the second user and is located within the predetermined range, via wireless communication;
a second wireless communication step of receiving, via wireless communication, additional information delivered by the audio processing apparatus; and
a control step of controlling the reproducing device by using the additional information received in the second wireless communication step.

13. A control method for an audio processing system that comprises an audio processing apparatus used by a first user and an assistant located within a predetermined range centered on the audio processing apparatus,
wherein the audio processing apparatus is caused to execute
an audio obtaining step of obtaining a voice of the first user as a first audio signal;
a first wireless receiving step of receiving, via wireless communication, from a first sound pickup device used by a second user located within the predetermined range, a voice of the second user, which is obtained as a second audio signal by the first sound pickup device;
a second wireless receiving step of receiving, via wireless communication, from a second sound pickup device used by a third user located within the predetermined range, a voice of the third user, which is obtained as a third audio signal by the second sound pickup device;
an audio signal processing step of processing the first audio signal, the second audio signal, and the third audio signal, and generating audio signals of a plurality of channels;
a first wireless delivering step of delivering, via wireless communication, the audio signals of the plurality of channels, which have been generated in the audio signal processing step, to a receiver located within the predetermined range;
a second wireless delivering step of delivering additional information associated with each of the plurality of channels to the assistant;
a switching step of switching a mute setting of each of the plurality of channels between an ON state and an OFF state in response to a user operation by the first user; and
a changing step, in which the additional information includes information about the mute setting of the associated channel, and in a case where the mute setting of a channel being selected by the receiver among the plurality of channels has been switched in the switching step, the information about the mute setting included in the additional information of the channel being selected, which is delivered in the second wireless delivering step, is changed to change a state of the receiver, and
wherein an information processing apparatus, which is used by the second user and serves as the assistant, is caused to execute
a first wireless communication step of transmitting and receiving signals to and from a reproducing device, which is used by the second user and serves as the receiver, via wireless communication;
a second wireless communication step of receiving, via wireless communication, the additional information of the channel being selected; and
a control step of controlling the reproducing device by using the additional information of the channel being selected, which has been received in the second wireless communication step.

14. A non-transitory computer-readable storage medium storing a program for causing a computer to execute a control method for an audio processing apparatus used by a first user, the control method comprising:
an audio obtaining step of obtaining a voice of the first user as a first audio signal;
a first wireless receiving step of receiving, via wireless communication, from a first sound pickup device used by a second user located within a predetermined range centered on the audio processing apparatus, a voice of the second user, which is obtained as a second audio signal by the first sound pickup device;
a second wireless receiving step of receiving, via wireless communication, from a second sound pickup device used by a third user located within the predetermined range, a voice of the third user, which is obtained as a third audio signal by the second sound pickup device;
an audio signal processing step of processing the first audio signal, the second audio signal, and the third audio signal, and generating an audio signal to be delivered through each of a plurality of channels;
a first wireless delivering step of delivering, via wireless communication, the audio signals of the plurality of channels, which have been generated in the audio signal processing step, to a receiver located within the predetermined range;
a second wireless delivering step of delivering additional information associated with each of the plurality of channels to an assistant that is located within the predetermined range and that transmits and receives signals to and from the receiver via wireless communication;
a switching step of switching a mute setting of each of the plurality of channels between an ON state and an OFF state in response to a user operation by the first user; and
a changing step, in which the additional information includes information about the mute setting of the associated channel, and in a case where the mute setting of a channel being selected by the receiver among the plurality of channels has been switched in the switching step, the information about the mute setting included in the additional information of the channel being selected by the receiver, which is delivered in the second wireless delivering step, is changed to change a state of the receiver.

15. A non-transitory computer-readable storage medium storing a program for causing a computer to execute a control method for an information processing apparatus used by a second user located within a predetermined range centered on an audio processing apparatus, the control method comprising:
a first wireless communication step of transmitting and receiving signals to and from a reproducing device, which is used by the second user and is located within the predetermined range, via wireless communication;
a second wireless communication step of receiving, via wireless communication, additional information delivered by the audio processing apparatus; and
a control step of controlling the reproducing device by using the additional information received in the second wireless communication step.

16. A non-transitory computer-readable storage medium storing a program for causing a computer to execute a control method for an audio processing system that comprises an audio processing apparatus used by a first user and an assistant located within a predetermined range centered on the audio processing apparatus,
wherein the audio processing apparatus is caused to execute
an audio obtaining step of obtaining a voice of the first user as a first audio signal;
a first wireless receiving step of receiving, via wireless communication, from a first sound pickup device used by a second user located within the predetermined range, a voice of the second user, which is obtained as a second audio signal by the first sound pickup device;
a second wireless receiving step of receiving, via wireless communication, from a second sound pickup device used by a third user located within the predetermined range, a voice of the third user, which is obtained as a third audio signal by the second sound pickup device;
an audio signal processing step of processing the first audio signal, the second audio signal, and the third audio signal, and generating audio signals of a plurality of channels;
a first wireless delivering step of delivering, via wireless communication, the audio signals of the plurality of channels, which have been generated in the audio signal processing step, to a receiver located within the predetermined range;
a second wireless delivering step of delivering additional information associated with each of the plurality of channels to the assistant;
a switching step of switching a mute setting of each of the plurality of channels between an ON state and an OFF state in response to a user operation by the first user; and
a changing step, in which the additional information includes information about the mute setting of the associated channel, and in a case where the mute setting of a channel being selected by the receiver among the plurality of channels has been switched in the switching step, the information about the mute setting included in the additional information of the channel being selected, which is delivered in the second wireless delivering step, is changed to change a state of the receiver, and
wherein an information processing apparatus, which is used by the second user and serves as the assistant, is caused to execute
a first wireless communication step of transmitting and receiving signals to and from a reproducing device, which is used by the second user and serves as the receiver, via wireless communication;
a second wireless communication step of receiving, via wireless communication, the additional information of the channel being selected; and
a control step of controlling the reproducing device by using the additional information of the channel being selected, which has been received in the second wireless communication step.
